(19) United States
(12) Patent Application Publication
(10) Pub. No.: US 2006/0033352 A1
(43) Pub. Date: Feb. 16, 2006

(54) Truck tailgate extension

(76) Inventors: James King, Rich Hill, MO (US); James Skocy, Rich Hill, MO (US)

Correspondence Address: SHUGHART THOMSON & KILROY, PC, 120 WEST 12TH STREET, KANSAS CITY, MO, 64105, US

(21) Appl. No.: 10/418,798

(22) Filed: Apr. 17, 2003

(51) Int. Cl. B62D 33/03

(52) U.S. Cl. 296/26.11

(57) ABSTRACT

A truck tailgate extension is provided having sidewalls that fold against a rear wall and the rear wall and folded or closed sidewalls can then hingedly collapse against the truck tailgate to permit the tailgate to close when the extension is not in use.

### STATEMENT REGARDING FEDERALLY SPONSORED RESEARCH

Not relevant.

### FIELD OF THE INVENTION

The present invention relates to enclosures for truck cargo areas. More particularly, the present invention relates to an extension piece for extending the side walls and rear wall of the truck cargo area. The extension is connected to the truck tailgate and may be opened when the tailgate is down to provide a rear wall and side wall extensions for the cargo area.

### BACKGROUND OF THE INVENTION

It is frequently of interest to pickup truck owners that they be able to carry material with the truck tailgate down to increase the usable loading area of the truck cargo area. It will be appreciated that when the truck tailgate is down no barrier is present to prevent materials from falling out of the truck cargo area. Therefore it has become useful to have available an extension piece which can be connected to the truck tailgate. Such an extension should provide an addition to the existing side walls of the cargo area and also provide a rear wall for the cargo area to replace the rear wall created by the truck tailgate which is in the down position.

Prior devices serving this purpose have generally consisted of some type of framework which can be attached to the rear of the truck or to the tailgate to provide the replacement rear wall and the extension of the cargo area side walls. The prior devices generally have been comprised of two side walls which are fixed to the rear wall and which are not movable with respect to the rear wall. When the extension piece is in use additional cargo space is available. However, when the extension piece is not in use and the tailgate is up the extension piece either takes up a considerable amount of space within the truck cargo area or the extension must be left in a garage or in storage and is therefore not available for use when the need arises.

Therefore, there has been a long felt need for an extension piece which can be attached to the tailgate of a pickup truck to provide the extension for the cargo area side walls and the addition of a rear wall when the tailgate is in the down position. It also would be of great benefit if the extension was able to fold or collapse into a small storage area so as not to consume a substantial amount of the pickup truck cargo area when the extension was not in use. It would be of further benefit if the extension was sufficiently collapsible so that it could be conveniently transported at all times with the truck so that it might be put into service as the need arises.

### SUMMARY OF THE INVENTION

It is an object of the present invention to provide a pickup truck cargo area side wall and rear wall extension piece which is attachable to the tailgate of the pickup truck.

It is another object of the present invention to provide a truck cargo area extension which is collapsible and can be folded up and stored within the truck cargo area in a small amount of space when the extension is not in use.

Yet another object of the present invention is to provide a truck cargo area extension which has a relatively open or porous rear wall to reduce the amount of wind resistence provided by the rear wall of the extension.

Yet another object of the present invention is to provide a pickup truck cargo area extension piece providing a rear wall and side wall extensions which can be folded against the rear wall and the rear wall which can be folded against the truck tailgate for storage when the extension is not in use.

These benefits and objects are achieved in the invention which is described hereinafter and which comprises an open or porous rear wall to reduce wind resistance comprised of a plurality of horizontally extending members or tubes which are vertically spaced apart and connected together by support uprights. The extension further comprises side wall extension pieces which are connected to the rear wall, the side wall extension pieces are also comprised of a relatively open configuration comprised of horizontally extending members or tubes which are supported by, and vertically spaced apart by support uprights, the side walls being hingedly connected to the rear wall to permit movement of the side walls between a closed position where the side wall is resting against the rear wall and an open position where the side wall is at approximately a 90-degree angle from the plane of the rear wall. The extension further comprises a second hinge means which connects the rear wall to the truck tailgate to permit the rear wall to fold against the tailgate when the side walls are in the closed position to allow for storage of the extension within the truck cargo area in a collapsed fashion.

The foregoing and other objects are intended to be illustrative of the invention and are not meant in a limiting sense. Many possible embodiments of the invention may be made and will be readily evident upon a study of the following specification and accompanying drawings comprising a part thereof. Various features and subcombinations of invention may be employed without reference to other features and subcombinations. Other objects and advantages of this invention will become apparent from the following description taken in connection with the accompanying drawings, wherein is set forth by way of illustration and example, an embodiment of this invention.

### DESCRIPTION OF THE DRAWINGS

Preferred embodiments of the invention, illustrative of the best modes in which the applicant has contemplated applying the principles, are set forth in the following description and are shown in the drawings and are particularly and distinctly pointed out and set forth in the appended claims.

FIG. 1 is a perspective view of the present invention mounted on the open tailgate of a truck;

FIG. 2 is a perspective view of the present invention mounted on the tailgate of a truck with the left side wall partially collapsed toward the rear wall and the right wall fully open;

FIG. 3 is a perspective view of the present invention with the left and right side walls collapsed against the rear wall and the rear wall folded downwardly against the truck tailgate;

FIG. 4 shows the present invention with the side walls collapsed against the rear wall and the rear wall folded downwardly against the tailgate and the tailgate fixed in its up and locked position against the cargo area of the truck;

FIG. 5 is a top and front perspective view of the present invention with the side walls in the open position;

FIG. 6 is a top and front perspective view of the present invention with the left side wall in the closed position and retained against the rear wall by a retaining means or strap; and

FIG. 7 is a cross-sectional view of one of the horizontally extending members or tubes in cross-sectional view to reveal the capture of an upright extending through voids in the tube or horizontally extending member and the upright captured by a clip or retaining means inserted into the tube the retaining means having glue thereon for fixing the relative position of the upright and the horizontally extending member or tube.

### DESCRIPTION OF THE PREFERRED EMBODIMENT

As required, detailed embodiments of the present inventions are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

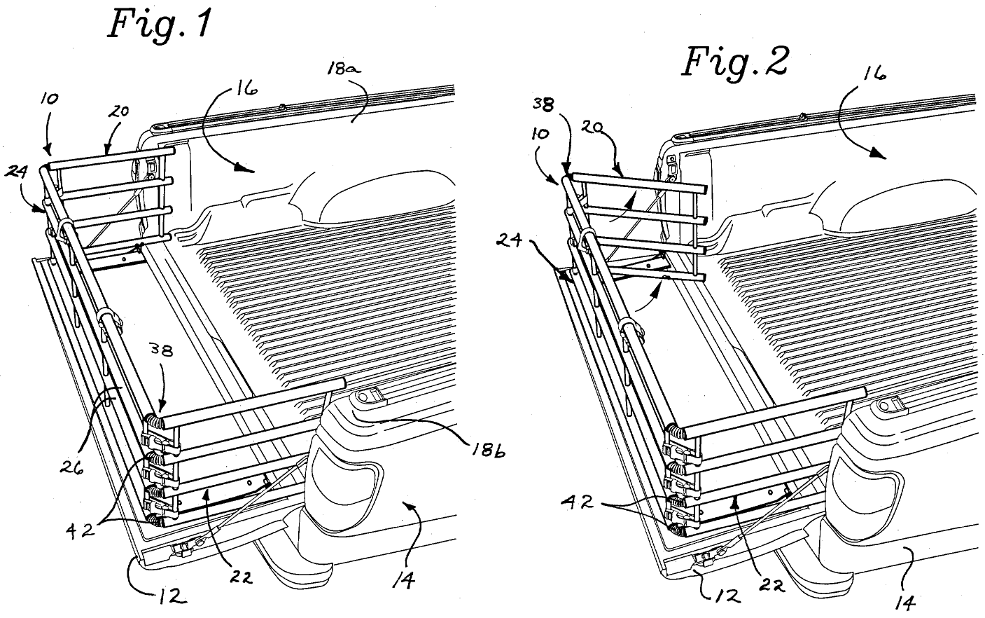

FIG. 1 shows the wall extension 10 of the present invention fully opened and mounted on tailgate 12 of truck 14. Truck 14 is a typical pickup truck having a cargo area 16 to which tailgate 12 is attached. Tailgate 12 is movable between an open or flat configuration as shown in FIG. 1 and a closed or upright position as shown in FIG. 4. As is shown in FIG. 1 wall extension 10 serves as a continuation or extension of truck cargo sides 18a, 18b by providing first or right side wall 20 of wall extension 10 and second or left side wall 22 of wall extension 10 which serve as continuations of truck cargo sides 18a, 18b. First side wall 20 and second side wall 22 are attached to rear wall 24 of wall extension 10 which serves to enclose the rear end of the enlarged cargo area 16 which is created by the addition of wall extension 10 comprised of rear wall 24 and first side wall 20 and second side wall 22. As will be discussed hereinafter wall extension 10 is removably or permanently fixed to tailgate 14 and is collapsible and foldable against tailgate 12 to allow tailgate 12 to be placed in its upright position to close off cargo area 16 as originally intended by the manufacturer of truck 14.

Referring now to FIG. 2 wall extension 10 is shown in partially collapsed condition with left or second side wall 22 opened from rear wall 24 of wall extension 10 and first side wall or right side wall 20 of wall extension 10 partially collapsed toward a closed position against rear wall 24.

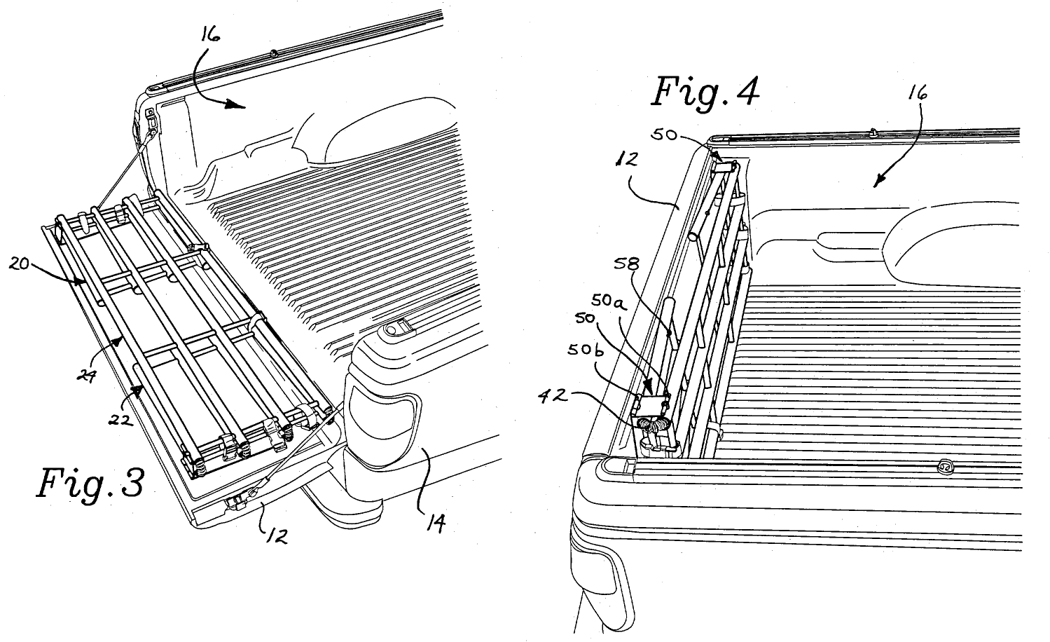

Referring now to FIG. 3 wall extension 10 of the present invention is shown with both side walls 20, 22 in the closed position and collapsed against rear wall 24 and rear wall 24 folded downwardly to rest against tailgate 12. In FIG. 4 side wall extension 10 has been completely collapsed against tailgate 12 of truck 14 as previously discussed in FIG. 3 and in FIG. 4. Tailgate 12 has been moved into its upright and locked position to close off cargo area 16 but with wall extension 10 attached to tailgate 12 while tailgate 12 is in its closed position.

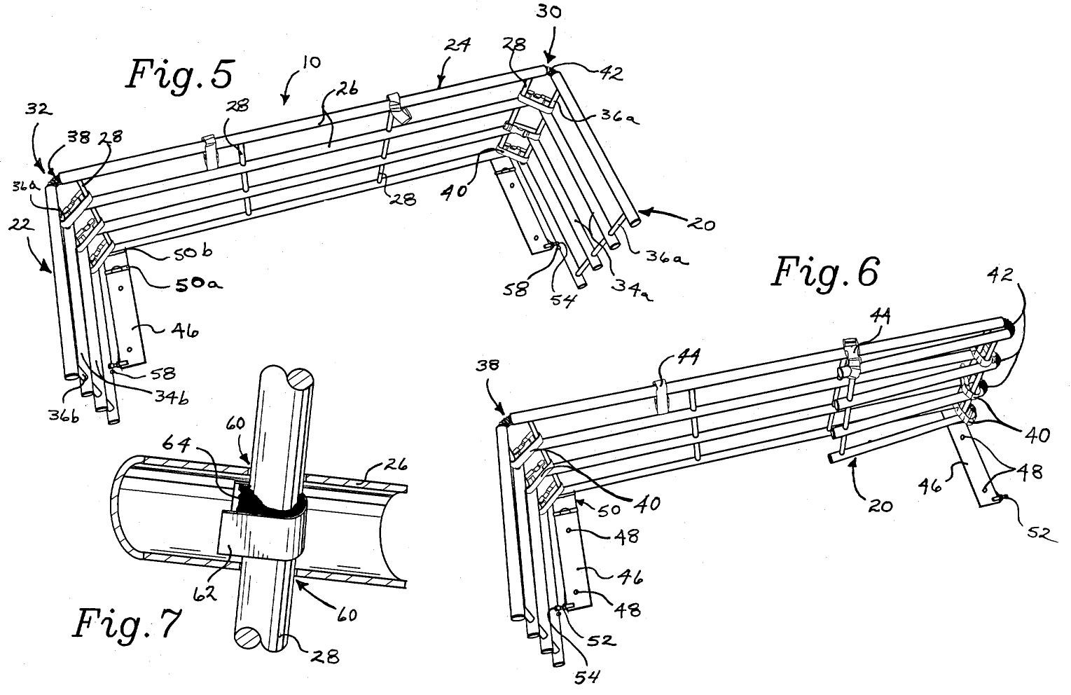

Referring now to FIGS. 5, 6 and 7 the construction and operation of the present invention will be described. First referring to FIG. 5 the wall extension 10 of the present invention is shown with side walls 20, 22 in their open position. Rear wall 24 of wall extension 10 is comprised of several vertically spaced, horizontal members 26 which extend the length of tailgate 12 but not so long as to prevent closure of the tailgate against cargo area 16 (FIG. 4). Horizontal members 26 are held in position by rear wall uprights 28 which are spaced along the horizontal axis of horizontal members 26. Rear wall horizontal members 26 terminate in rear wall first end 30 and rear wall second end 32 to which are joined first side wall 20 and second side wall 22 respectively.

First or right side wall 20 and second or left side wall 22 are in a preferred embodiment comprised of similar construction as is rear wall 24. Specifically, side walls 20, 22 are comprised of a plurality of side wall horizontal members 34a, 34b which are spaced apart vertically and supported by a plurality of side wall uprights 36a, 36b which retain horizontal members 34a, 34b in their vertically spaced apart position. It will be appreciated that the spacing between rear wall horizontal members 26 and side wall horizontal members 34a, 34b are, in a preferred embodiment, similarly vertically spaced apart for convenience of connection by the hinge means 38 provided in the preferred embodiment.

The hinge means 38 of the preferred embodiment is comprised of a spring which is inserted into or connected to one or more of rear wall horizontal members 26. The hinge means or spring also is connected to one or more of horizontal members 34a, 34b of side walls 20, 22 to provide hinged, or openable and closable, connection between rear wall 24 and side walls 20, 22. In a preferred embodiment the hinge means 38 is a stainless steel spring 42 of approximately 2.75 inches in length and having an outer diameter of 0.849 inches. Spring 42 is inserted into the open end of each of rear wall horizontal members 26 which are comprised of stainless steel tubing having an outer diameter of one inch and a wall thickness sufficient to provide frictional fit capture of spring 42 of hinge means 38 within the horizontal member. The spring extends from each of horizontal members 26 at either end to provide aligned connection of the spring with one end of each vertically spaced horizontal member 34a, 34b comprising side walls 20, 22. The spring is inserted into one end of each of horizontal members 34a, 34b of side walls 20, 22 and is retained in place by frictional forces between the spring and the horizontal member or tube. Those skilled in the art will appreciate that the spring comprising first hinge means 38 could be substituted with a flexible rubber connection or with a hinge such as a door hinge or a piano hinge or an individual hinge which is designed to insert into the hollow tubes of each of horizontal members 26 and connect to each of horizontal members 34a, 34b. Alternatively, the hinge could be connected between adjacent uprights of rear wall 24 and side walls 20, 22 to effect the desired hinged movement of side walls 20, 22 between open and closed positions with respect to rear wall 24. It will be appreciated that side walls 20, 22 are shown in the open position in FIG. 5 and that in FIG. 6 side wall 20 is shown in the closed position while side wall 22 is shown in the open position.

Referring now to FIG. 6 it can be appreciated that in a preferred embodiment using springs inserted into tubular stainless steel members comprising horizontal members 26, 34a, 34b that the springs are restrained from opening into their fully relaxed position by side wall restraints 40. If springs 42 which comprise first hinge means 38 in a preferred embodiment, were allowed to move into their fully relaxed position side walls 20, 22 would move into a single plane with rear wall horizontal members 26. As shown in FIGS. 5 and 6 side walls 20, 22 are prevented from movement into such a fully relaxed position of spring 42 by the use of side wall restraints 40 which retain side walls 20, 22 in an open position of approximately 90 degrees with respect to rear wall 24. From this 90-degree open position side walls 20, 22 can be moved into a closed position as shown in FIG. 6 by side wall 20 wherein side wall 20 has been collapsed against rear wall 24 and is held against rear wall 24 by capture within strap 44 which serves to hold side walls 20, 22 in the closed position against rear wall 24. As previously described in the discussion of FIGS. 2-4 the movement of side walls 20, 22 into the closed position where they are retained against rear wall 24 by straps 44 allows wall extension 10 to be folded downwardly against tailgate 12 and to allow tailgate 12 to be closed against cargo area 16 (FIG. 4).

The folding movement of wall extension 10 against tailgate 12 is accomplished by the use of a second hinge means 50 which is part of the connection of rear wall 24 to tailgate 12. Still referring to FIGS. 5 and 6 mounting plate 46 is shown which is used to attached wall extension 10 to tailgate 12 by the use of screws inserted through mounting plate screw voids 48 which are provided in each mounting plate 46. Mounting plate 46 is connected to rear wall 24 by second hinge means 50. Second hinge means 50 is a double hinge which is comprised of hinge 50a and hinge 50b which allows rear wall 24 to be folded downwardly against tailgate 12 while accounting for the additional width of the collapsed wall extension 10 which is presented when side walls 20, 22 are closed against rear wall 24.

As can be seen in FIGS. 4 and 6 hinge portions 50a, 50b of hinge means 50 are spaced apart to allow capture of side walls 20, 22 between rear wall 24 and mounting plate 46 when wall extension 10 is in its collapsed and folded position against tailgate 12. Referring now to FIGS. 4 and 6, side wall 20 is shown in its closed position against rear wall 24 and the mounting plate adjacent side wall 20 is shown in its collapsed position in which it is pressed against side wall 20. It can be appreciated in FIGS. 4 and 6 that the spacing between hinge portion 50a and hinge portion 50b of second hinge means 50 allows second hinge means 50 to be collapsed against rear wall 24 while taking into account the spacing of second hinge means 50 from rear wall 24 caused by side wall 20 being pressed against rear wall 24 into its closed position.

Still referring to FIG. 6 the connection between mounting plate 46 in side walls 20, 22 will be described. A connection between side walls 20, 22 and mounting plate 46 is provided to securely retain side walls 20, 22 in the open position when wall extension 10 is in use on truck 14 as shown in FIG. 1. To retain side walls 20, 22 in a fixed position securing posts 52 are provided toward the outside edge of each of mounting plates 46. Securing posts 52 is adapted to be inserted into post void 54 which is provided within the bottom-most horizontal member 34a, 34b of each of side walls 20, 22. Securing post 52 in a preferred embodiment is provided with a round head thereon which is inserted into post void 54 where it is captured by post catch 56 (not shown) and which is contained within the bottom-most horizontal member 34a, 34b of side walls 20, 22. When it is desired to collapse side walls 20, 22 against rear wall 24 of wall extension 10 catch release button 58 is depressed which releases post catch 56 from capture of securing post 52 and allows side walls 20, 22 to be released from mounting plate 46 thereby permitting movement of side walls 20, 22 from the open position as shown in FIG. 5 and into the closed position as shown for side wall 20 in FIG. 6.

The securing together of horizontal members 26, 34a, 34b with uprights 28, 36a, 36b under the method of construction of the present invention of wall extension 10 will now be described. In a preferred embodiment of wall extension 10 horizontal members 26, 34a, 34b are comprised of tubular stainless steel which has a completely hollow interior and which has been provided with spaced apart voids 60 to permit insertion of uprights 28, 36a, 36b therein. Uprights 28, 36a, 36b retain horizontal members 26, 34a, 34b in their spaced apart positioning and through the use of a clip or holding means 62 inserted into each horizontal member 26, 34a, 34b. Holding means 62 captures the portion of upright 28, 36a, 36b which is within the horizontal members. The positions of horizontal members and uprights can be fixed with respect to one another and then secured into position through the use of an epoxy glue 64.

This process will now be described by reference to FIG. 7 wherein a portion of one of the plurality of rear wall horizontal members 26 is shown in cross-sectional view with a portion of rear wall upright 28 inserted into voids 60 in horizontal member 26. During construction of wall extension 10 the stainless steel tubing comprising horizontal member 26 is provided with aligned voids 60 on opposite sides of horizontal member 26 which allow for insertion of upright 28 there through. It will be appreciated that without some sort of holding means that horizontal member 26 could simply slide along the length of rear wall upright 28. To prevent this relative movement between horizontal member 26 and upright 28 clip 62 is inserted into tubular horizontal member 26 until it captures the portion of upright 28 which is contained within horizontal member 26. If a sufficiently tight frictional fit is accomplished, clip 62 alone could hold upright 28 and horizontal member 26 in a fixed position relative to one another. However, the method of construction of the present wall extension 10 provides for the use of an epoxy glue 64 which is applied to clip 62 prior to insertion of clip 62 into horizontal member 26 for capture of upright 28. Therefore, the presence of epoxy 64 on clip 62 allows for both frictional fit capture of upright 28 by clip 62 and for the application of epoxy 64 to both upright 28, clip 62 and the interior of horizontal member 26. Upon solidification of epoxy 64 horizontal member 26 is rigidly connected with upright 28 whereby a strong rigid connection is provided which allows the finally constructed wall extension 10 to lift nearly 2,000 pounds when the weight is attached to the bottom-most horizontal member 26 and lifting force is applied to the uppermost horizontal member 26. Therefore, the connection provided by clip 62 and epoxy 64 is strong and well suited to the heavy duty purposes for which wall extension 10 is designed.

Having thus described the invention what is claimed as new and desired to be secured by Letters Patent is as follows:

1. A wall extension for attachment to the tailgate of a truck, said guard comprising:
a rear wall having first and second ends,
first and second sidewalls connected to said wall first and second ends, and
hinge means connecting said sidewalls to said wall first and second ends for movement of said sidewalls between an open position and a closed position.

2. The wall extension as claimed in claim 1 further comprising a second hinge means connecting said wall extension to the tailgate.

3. The wall extension as claimed in claim 1 further comprising a mounting plate attached to the truck tailgate and connecting said rear wall to the tailgate.

4. The wall extension as claimed in claim 3 further comprising a second hinge means connecting said plate to said rear wall to permit said wall extension to fold against the tailgate.

5. The wall extension as claimed in claim 1 wherein said hinge means comprises a flexible connection between said rear wall and said sidewalls.

6. The wall extension as claimed in claim 1 wherein said hinge means comprises a spring.

7. The wall extension as claimed in claim 1 wherein said hinge means comprises a flexible rubber or plastic connector.

8. A wall extension for mounting on a truck tailgate to enclose the truck bed when the tailgate is in an open position comprising:
a rear wall comprising:
a plurality of vertically-spaced, horizontally extending members having first and second ends, and
a plurality of horizontally-spaced uprights connecting said members,
first and second sidewalls connected to said first and second rear wall ends,
a first hinge means connecting said first and second sidewalls to said first and second rear wall ends,
a mounting plate attached to the truck tailgate, and
a second hinge means connecting said plate to said rear wall to permit said rear wall to fold against the tailgate

9. The wall extension as claimed in claim 8 wherein said horizontally extending members are tubes.

10. The wall extension as claimed in claim 8 wherein said sidewalls comprise:
a plurality of vertically-spaced, horizontally extending members having first and second ends, and
a plurality of horizontally-spaced uprights connecting said members.

11. The wall extension as claimed in claim 10 wherein said rear wall horizontally extending members and sidewall horizontally extending members are comprised of tubes.

12. The wall extension as claimed in claim 9 further comprising:
a plurality of voids in said horizontally extending tubes for receiving therein said uprights for connecting together said tubes, and
a securing means inserted into at least one of said plurality of horizontally extending tubes said securing means capturing said upright to hold said upright and said tube in fixed relation.

13. The wall extension as claimed in claim 9 further comprising retaining means connected between said rear wall and said first and second sidewalls to limit the open position of said sidewalls.

14. A wall extension for mounting on a truck tailgate to enclose the truck bed when the tailgate is in an open position comprising:
a rear wall comprising:
a plurality of vertically-spaced, horizontally extending tubes each tube terminating in a pair of ends, and
a plurality of horizontally-spaced uprights connecting said tubes,
first and second sidewalls comprising:
a plurality of vertically-spaced, horizontally extending tubes each tube terminating in a pair of ends, and
a plurality of horizontally-spaced uprights connecting said tubes,
a spring extending from said rear wall tube ends and into one end of said first and second sidewall tubes to foldably connect said first and second sidewalls to said rear wall,
a mounting plate attached to the truck tailgate, and
second hinge means connecting said plate to said rear wall to permit said wall to fold against the tailgate.

15. The wall extension as claimed in claim 14 further comprising a securing means inserted into at least one of said plurality of horizontally extending tubes said securing means capturing said upright to hold said upright and said tube in fixed relation.

16. A method of assembling the horizontally extending members and the vertically extending members of a wall extension for mounting on a truck tailgate to enclose the truck bed when the tailgate is in an open position comprising:
providing an open ended tube,
creating a void along the length of said tube,
inserting an upright into said void,
providing an upright retaining means,
applying a glue to said retaining means to provide a glue covered retaining means,
inserting said glue covered retaining means into said tube open end,
pressing said glue covered retaining means against said upright,
capturing said upright with said retaining means to hold said upright within said tube, and
allowing said glue to harden to fix the position of said retaining means.

17. The method as claimed in claim 16 wherein said retaining means is a generally C-shaped clip.

18. The method as claimed in claim 16 wherein said glue is an epoxy glue.
